(19) United States
(12) Patent Application Publication
(10) Pub. No.: US 2026/0150171 A1
(43) Pub. Date: May 28, 2026

(54) LAMP SPLITTER, LIGHTING SYSTEM AND SIGNAL SPLITTING METHOD

(71) Applicant: Shenzhen Shimu Technology Co., Ltd., Shenzhen (CN)

(72) Inventor: Zili Sheng, Xiaogan (CN)

(21) Appl. No.: 19/399,813

(22) Filed: Nov. 25, 2025

(30) Foreign Application Priority Data
Nov. 26, 2024 (CN) 202411707982.8

(51) Int. Cl. H05B 47/175; H05B 47/155; H05B 47/18

(52) U.S. Cl. CPC H05B 47/198; H05B 47/155; H05B 47/18; H05B 47/196

(57) ABSTRACT

A lamp splitter, a lighting system, and a signal splitting method are provided. The lamp splitter includes a decoding module configured to decode an input original single line data signal to output decoded data; a branch lamp number confirmation module configured to confirm a configuration information of a branch lamp number for each branch; and a branch data output module configured to allocate the decoded data to each branch according to the configuration information of the branch lamp number for each branch. According to the lamp splitter, the lighting system, and the signal splitting method of the present disclosure, independent control of lamps can be achieved, which can improve the flexibility and reliability of the system.

### CROSS-REFERENCE TO RELATED APPLICATIONS

This application claims priority to Chinese Patent Application No. 202411707982.8, filed on Nov. 26, 2024, which is hereby incorporated by reference in its entirety.

### TECHNICAL FIELD

The present disclosure relates to the field of lamps technologies, and in particular, to a lamp splitter, a lighting system and a signal splitting method.

### BACKGROUND

With the development of smart homes and urban landscape lighting, colorful lighting fixtures are becoming increasingly popular in the market due to their ability to provide colorful lighting effects. These lighting fixtures are usually composed of a plurality of addressable LED light beads, which can achieve complex light and shadow effects through a precise control. They are commonly used in fields such as festival decoration, stage lighting, commercial advertising, etc.

In existing technology, iridescent lamps are usually controlled using a single line protocol, such as a single line zeroing code protocol. This protocol controls all lighting fixtures through a signal line, and a controller transmits a control instruction by changing the voltage level on the signal line. The addressable Integrated Circuit Chip, (IC) within each lamp or lamp group receives the instruction, and controls the brightness and color of the LED light beads according to the instruction.

The above control way is simple and cost-effective, but because all lamps share the same signal line, it can only achieve synchronous control of all lamps, that is, it can only output the same signal to each branch and cannot achieve independent and precise control of individual lamps or lamp groups. This means that it is not possible to create unique lighting effects for each lamp or lamp group, thereby limiting the flexibility and creativity of lighting design. Besides that, when the number of lighting fixtures are increased, sharing signal lines may cause signal interference and attenuation, thereby affecting the stability and reliability of the control signal.

Therefore, the existing technology requires a signal splitting device that can independently control a plurality of output terminals to provide a more flexible and stable lighting control solution.

### SUMMARY

The present disclosure aims to provide a lamp splitter, a lighting system, and a signal splitting method that can achieve independent control of lamps, improve the flexibility and reliability of the system.

In view of this, a first aspect of the present disclosure provides a lamp splitter including: a decoding module, configured to decode an input original single line data signal to output decoded data; a branch lamp number confirmation module, configured to confirm a configuration information of a branch lamp number for each branch; and a branch data output module, configured to allocate the decoded data to each branch according to the configuration information of the branch lamp number for each branch.

In the present disclosure, by decoding the original single line data signal, the branch data output module can allocate the decoded data to each branch according to the configuration information of the branch lamp number for each branch. Therefore, independent control of the lamps or lamp groups in each branch can be achieved, which can improve the flexibility and reliability of the system

In some embodiments of the present disclosure, the original single line data signal includes a plurality of 0 codes and a plurality of 1 codes, where the 0 codes have a high level with a first predetermined pulse width, and the 1 codes have a high level with a second predetermined pulse width, where the second predetermined pulse width is greater than the first predetermined pulse width; the decoding module includes a clock signal generation unit, configured to generate a first pulse signal with a third predetermined pulse width when a high-level duration of a first initial signal corresponding to the original single line data signal is greater than a high-level duration of the 0 codes so as to generate a clock signal.

In some embodiments of the present disclosure, the third predetermined pulse width is not greater than a difference between the second predetermined pulse width and the first predetermined pulse width.

In some embodiments of the present disclosure, the decoding module includes a first determination unit, where the first determination unit is configured to: sample the original single line data signal at a position where the clock signal has the first pulse signal, determine that a decoding bit is the 0 codes when the decoding bit of the original single line data signal corresponding to the first pulse signal is at a low level; and determine that the decoding bit is the 1 codes when the decoding bit of the original single line data signal corresponding to the first pulse signal is at a high level.

In some embodiments of the present disclosure, the decoding module includes an NSS signal generation unit, where the NSS signal generation unit is configured to generate a second pulse signal with a fourth predetermined pulse width based on a first high-level rising edge of the second initial signal corresponding to the original single line data signal to generate an NSS signal, and an endpoint of the second pulse signal is an end of a data frame in the original single line data signal.

In some embodiments of the present disclosure, the decoding module includes a second determination unit, where the second determination unit is configured to determine that a position of the original single line data signal is the end of a data frame when a low-level time of the original single line data signal exceeds a preset time.

In some embodiments of the present disclosure, the original single line data signal carries the configuration information of the branch lamp number for each branch.

In some embodiments of the present disclosure, the configuration information of the branch lamp number for each branch is sent to the branch lamp number confirmation module through a user terminal.

In some embodiments of the present disclosure, the lamp splitter further includes a configuration module, configured to configure the configuration information of the branch lamp number for each branch, and send the configuration information of the branch lamp number for each branch to the branch lamp confirmation module.

In some embodiments of the present disclosure, the branch lamp number confirmation module includes a plurality of cascaded branching devices, the original single line data signal includes configuration information for each lamp, and the configuration information includes the configuration information of the branch lamp number; the branching devices are configured to recognize the configuration information of the branch lamp number.

In some embodiments of the present disclosure, the branch data output module allocates the decoded data to each branch through a Serial Peripheral Interface, (SPI) or a Pulse-width modulation, (PWM) analog single line protocol.

A second aspect of the present disclosure provides a signal splitting method, including: decoding an input original single line data signal to output decoded data; confirming a configuration information of a branch lamp number for each branch; and allocating the decoded data to each branch according to the configuration information of the lamp number for each branch.

A third aspect of the present disclosure provides a lighting system, including: a controller, a plurality of lamps and a plurality of lamp control chips that are provided in a plurality of branches, and the lamp splitter, where the lamp splitter has a plurality of output terminals, and the plurality of output terminals are respectively connected to the plurality of branches; each lamp is provided with at least one lamp control chip, and the controller is configured to output an original single line data signal to the splitter; the lamp splitter is configured to decode the original single line data signal and independently allocate to the lamp control chips that are connected to the lamps in the plurality of branches, and then control lighting states of the lamps by the lamp control chips.

According to the lamp splitter, the lamp system, and the signal splitting method of the present disclosure, independent control of lamps can be achieved, which can improve the flexibility and reliability of the system.

### BRIEF DESCRIPTION OF DORIGINALINGS

The present disclosure will now be further explained in detail only by referring to embodiments in the accompanying drawings.

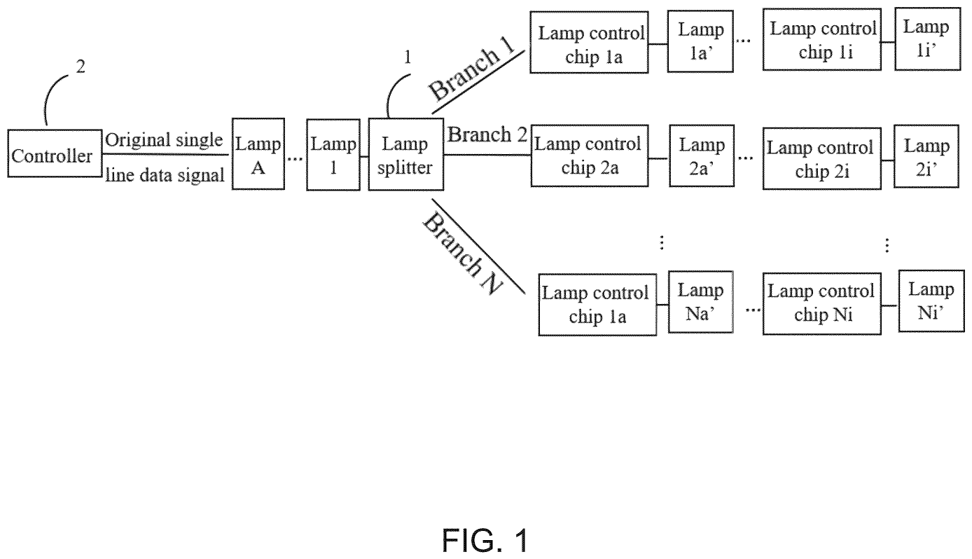

FIG. 1 is a functional module diagram of a lighting system according to an embodiment of the present disclosure.

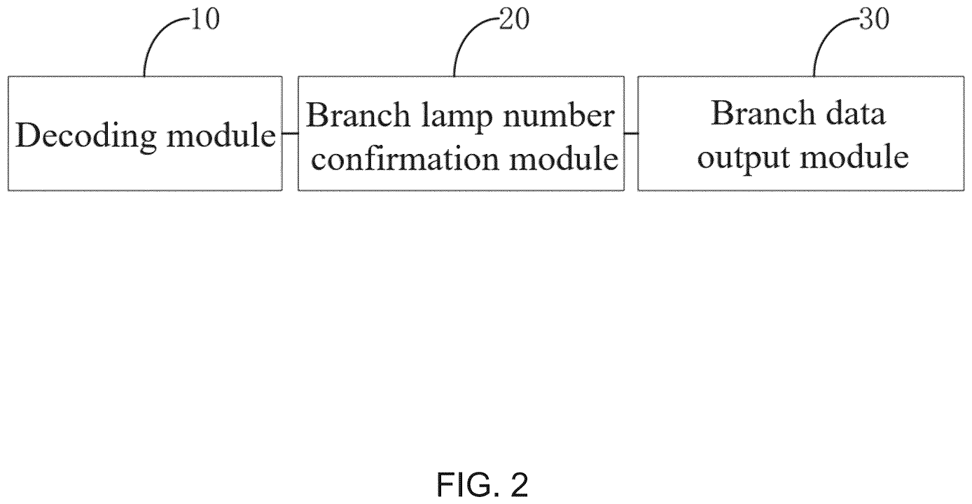

FIG. 2 is a functional module diagram of a lamp splitter in a first embodiment of the present disclosure.

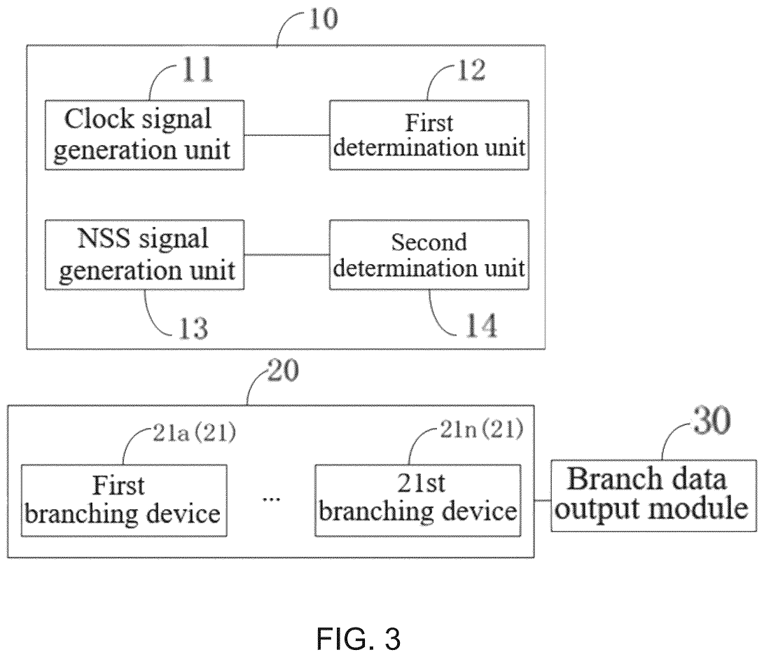

FIG. 3 is a functional module diagram of the lamp splitter in a second embodiment of the present disclosure.

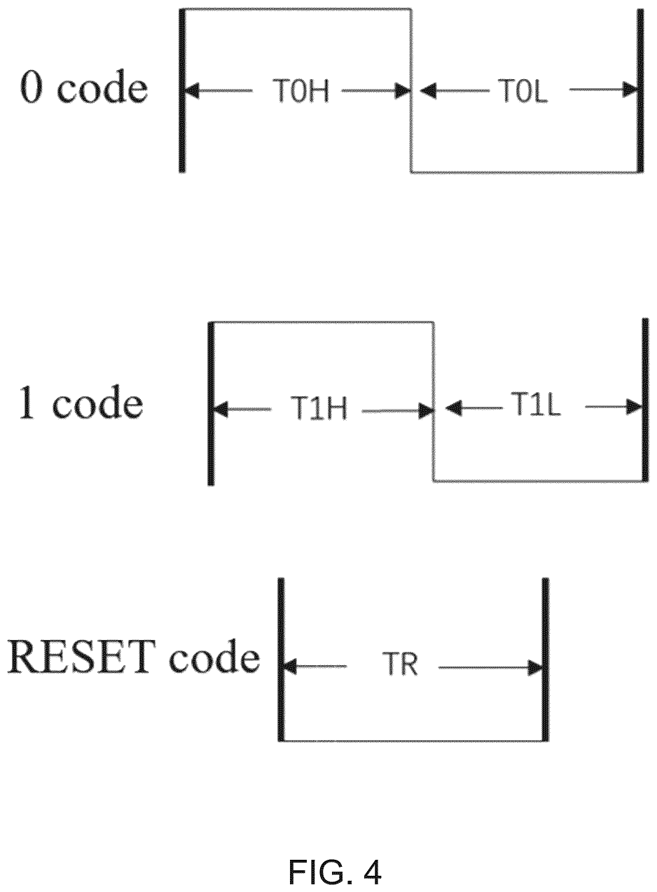

FIG. 4 is a schematic diagram showing 0 code, 1 code, and Reset code in an embodiment of the present disclosure.

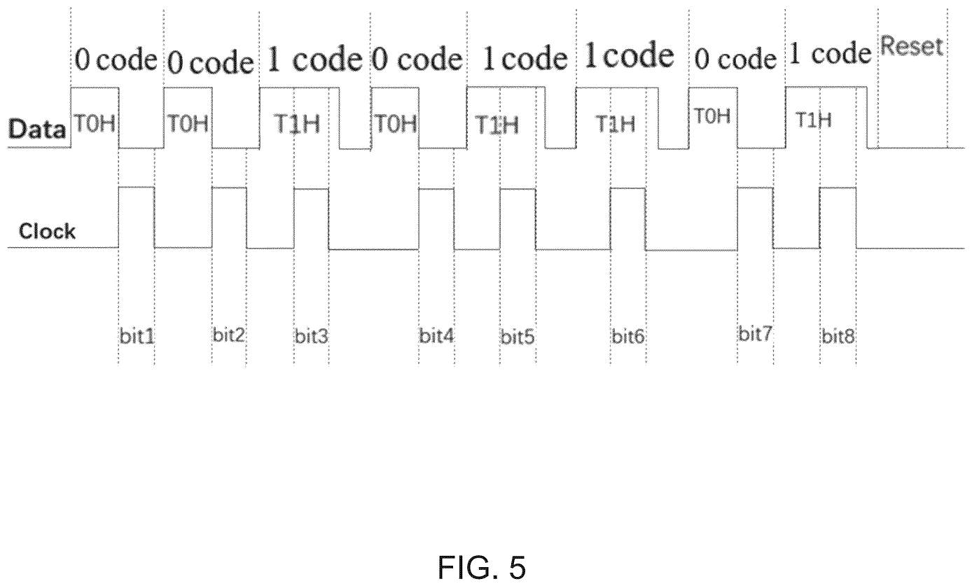

FIG. 5 is a schematic diagram showing an original single line data signal and a clock signal in an embodiment of the present disclosure.

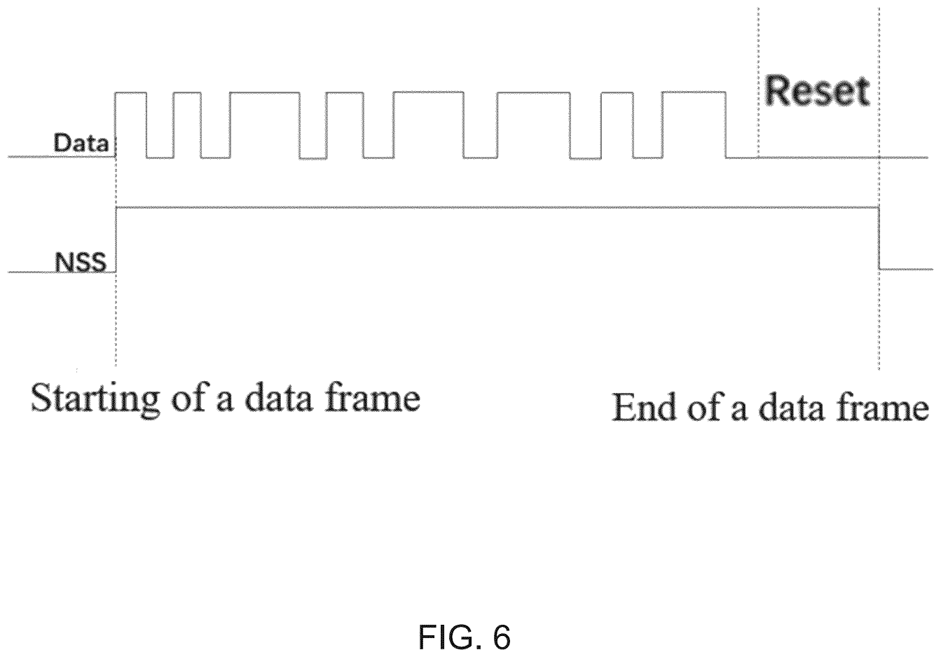

FIG. 6 is a schematic diagram showing the original single line data signal and an NSS signal in an embodiment of the present disclosure.

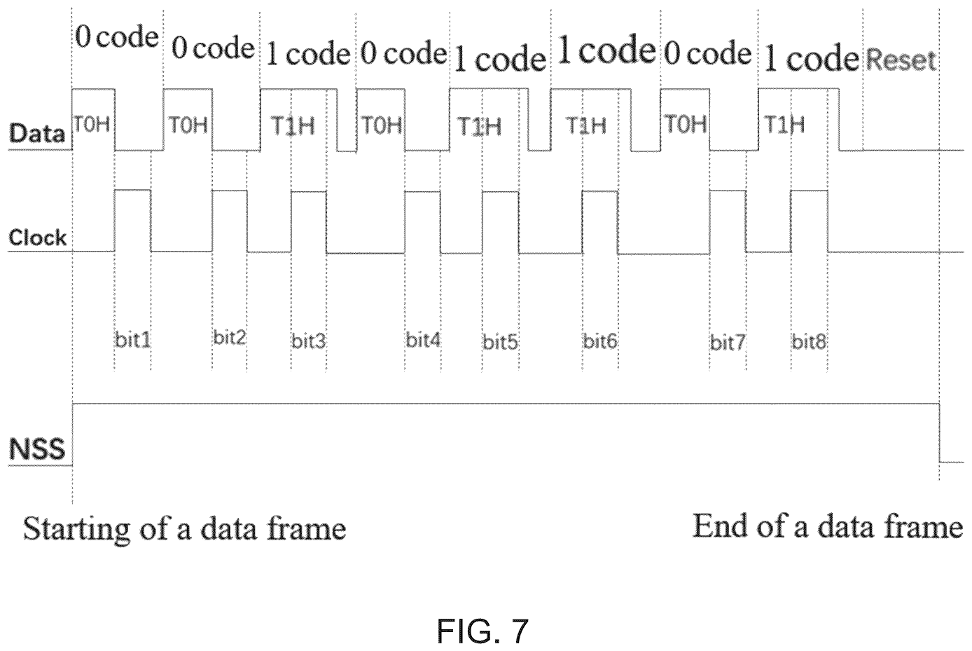

FIG. 7 is a schematic diagram showing the original single line data signal, clock signal, and NSS signal in an embodiment of the present disclosure.

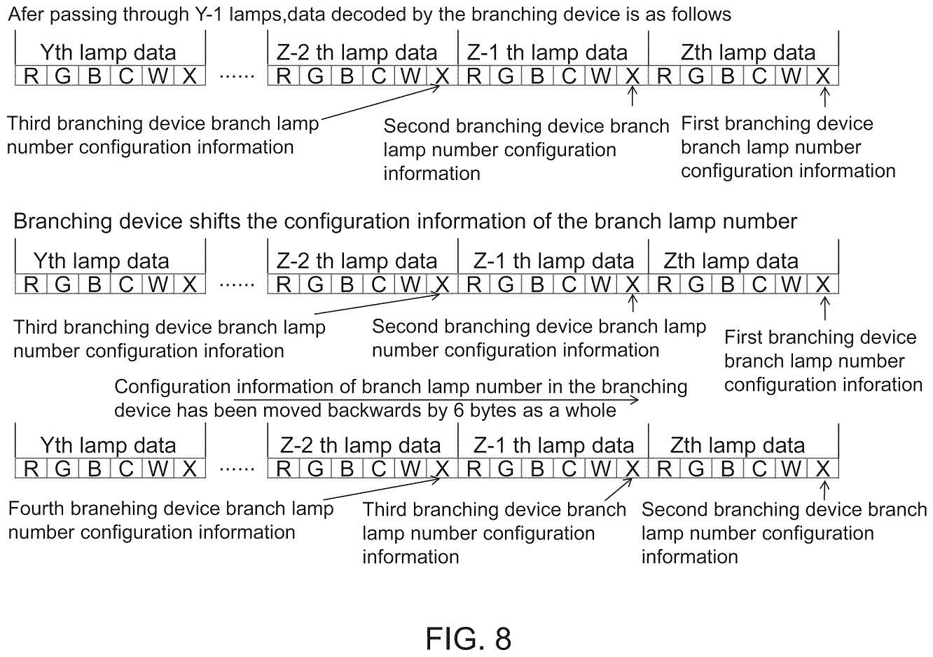

FIG. 8 is a schematic diagram showing a configuration information of identifying branch lamp number in a branching device in an embodiment of the present disclosure.

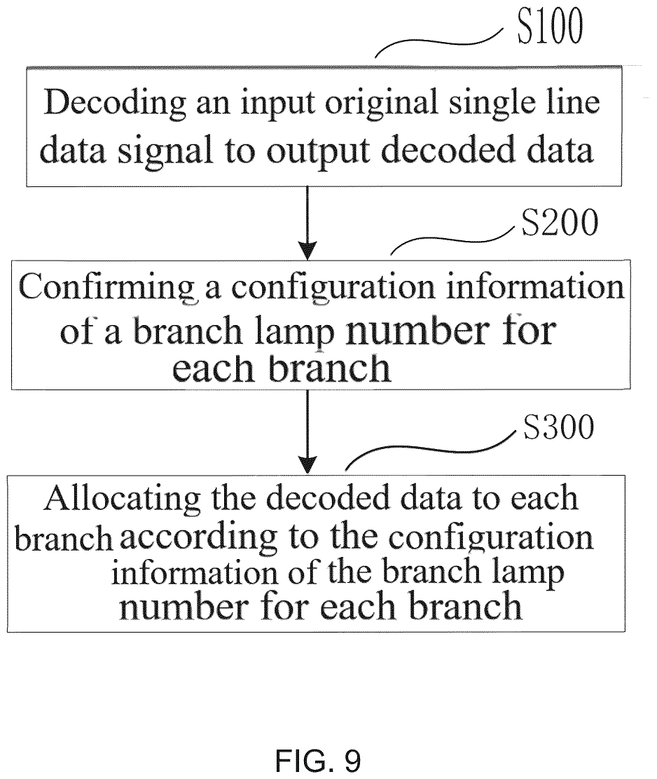

FIG. 9 is a flowchart illustrating a signal splitting method according to an embodiment of the present disclosure.

### DESCRIPTION OF EMBODIMENTS

Below, with reference to the accompanying drawings, the preferred embodiments of the present disclosure will be described in detail. In the following explanation, the same symbols are referred to the same components, and repeated explanations are omitted. In addition, the attached diagrams are only schematic diagrams, and the proportion of dimensions between components or the shape of components may differ from an actual situation.

It should be noted that terms “including” and “comprising” in the present disclosure, as well as any variations thereof, such as processes, methods, systems, products, or devices that include or have a series of steps or units, are not necessarily limited to those clearly listed, but may include or have other steps or units that are not clearly listed or inherent to these processes, methods, products, or devices.

The present disclosure aims to provide a lamp splitter 1, a lighting system, and a signal splitting method that can achieve independent control of lamps, improve the flexibility and reliability of the system.

In an embodiment of the present disclosure, the present disclosure provides a lighting system. The lighting system can also be called a lighting control system or a colorful lighting control system.

Referring to FIG. 1, the lighting system may include a controller 2, a plurality of lamps (such as lamp 1, lamp 2, . . . lamp N) that are provided in a plurality of branches (such as branch 1, branch 2, . . . branch N), a plurality of lamp control chips (such as lamp control chip 1, lamp control chip 2, . . . lamp control chip N), and a light splitter 1.

In some embodiments, each branch can be provided with a plurality of lamps, and each lamp can be controlled by at least one lamp control chip connected to it. For example, branch 1 can include lamp 1a, . . . lamp 1i, as well as lamp control chip 1a′, . . . lamp control chip 1i+, etc. the lamp 1a can be controlled by the lamp control chip 1a′, and the lamp 1i can be controlled by the lamp control chip 1i′; the branch 2 can include lamp 2a, . . . lamp 2i, as well as lamp control chip 2a′, . . . lamp control chip 2i′, etc. the lamp 2a can be controlled by the lamp control chip 2a′, and the lamp 2i can be controlled by the lamp control chip 2i′; the branch N can include lamp Na, . . . lamp Ni, as well as lamp control chip Na′, . . . the lamp control chip Ni′, etc. the lamp Na can be controlled by the lamp control chip Na′, and the lamp Ni can be controlled by the lamp control chip N1i′.

In some embodiments, the lamp may be, for example, iridescent lighting fixtures.

In some embodiments, the lamp splitter 1 may be placed between the controller 2 and the lamp. The lamp splitter 1 can have one input terminal and a plurality of output terminals, and the plurality of output terminals can be connected to the plurality of branches respectively. At least one lamp can be provided in each branch. Each lamp can be provided with at least one lamp control chip.

Of course, it can be understood that a plurality of lamps can also be provided between the controller 2 and the lamp splitter 1, such as lamp A, . . . lamp I, etc. where, a connection method of the plurality of lamps can be parallel, series, or both parallel and series.

In some embodiments, the controller 2 may be configured to output an original single line data signal to the lamp splitter 1.

In some embodiments, the lamp splitter 1 can be configured to decode the original single line data signal and independently allocate it to the lamp control chips connected to the lamps in the plurality of branches, and then control lighting states of the lamps by the lamp control chips. In the lighting system of the present disclosure, independent control of the lamps in the plurality of branches can be achieved, which can improve the flexibility and reliability of the system.

In some embodiments, the lighting system may include a plurality of lamp splitters 1. Each lamp splitter 1 can independently control a certain number of branches.

In some embodiments, the lighting system may include a central controller and a user interface. The lighting system coordinates the operation of all lamp splitters through the central controller, thereby ensuring synchronization and consistency of the entire system. The central controller can monitor the state of each branch in real-time and adjust signal allocation strategies as needed. By providing a user-friendly interface, a user can easily configure and adjust the number of lamps and other parameters for each branch. This interface can be graphical, supports drag and drop operations, and can preview lighting effects in real-time.

The present disclosure further provides a lamp splitter 1. The lamp splitter 1 of the present disclosure can also be referred to as a multi-channel output independent controller, a signal splitting device for iridescent lighting fixture, or simply as the lamp splitter 1.

Referring to FIG. 2, in some embodiments, the lamp splitter 1 may include a decoding module 10. The decoding module 10 can be configured to decode an input original single line data signal to output decoded data.

In some embodiments, the lamp splitter 1 may include a branch lamp number confirmation module 20. The branch lamp number confirmation module 20 can be configured to confirm a configuration information of a branch lamp number for each branch.

In some embodiments, the lamp splitter 1 may include a branch data output module 30. The branch data output module 30 can be configured to allocate the decoded data to each branch according to the configuration information of the branch lamp number for each branch.

In the present disclosure, decoding the original single line data signal can obtain specific composition information of the original single line data signal, and then enable the branch data output module to allocate the decoded data to each branch according to the configuration information of the branch lamp number. Therefore, independent control of the lamps or lamp groups in each branch can be achieved, which can improve the flexibility and reliability of the system.

The original single line data signal can be an original signal transmitted to the lamp splitter 1 through a single line protocol.

In some embodiments, referring to FIG. 4, the original single line data signal may include a plurality of 0 codes and a plurality of 1 codes. The 0 codes can have a high level (T0H) with a first predetermined pulse width. The 1 codes can have a high level (T1H) with a second predetermined pulse width. The second predetermined pulse width may be greater than the first predetermined pulse width. In addition, the 0 codes and 1 codes can also have a certain pulse width of low level (T0L, T1L).

In some embodiments, referring to FIGS. 3 and 5, the decoding module 11 may include a clock signal generation unit 11. The clock signal generation unit 11 can be configured to generate a first pulse signal with a third predetermined pulse width (i.e. bit1, bit 2, . . . bit 8, etc. in FIG. 5) when a high-level duration of a first initial signal corresponding to the original single line data signal (i.e. data in FIG. 5) is greater than a high-level duration of 0 codes, and generate a clock signal (i.e. clock in FIG. 5) by combining all first pulse signals.

In some embodiments, an idle level of the first initial signal may be a low level (taking a low level as an example in FIG. 5). In other embodiments, the idle level of the first initial signal may also be a high level.

In some embodiments, the third predetermined pulse width may not be greater than a difference between the second predetermined pulse width and the first predetermined pulse width.

In some embodiments, referring again to FIG. 5, the decoding module may include a first determination unit 12. The first determination unit 12 can be configured to sample the original single line data signal at a position where the clock signal has the first pulse signal, and determine that a decoding bit is the 0 code when it is sampled out that the decoding bit of the original single line data signal corresponding to the first pulse signal is at a low level; and determine that the decoding bit is the 1 code when it is sampled out that the decoding bit of the original single line data signal corresponding to the first pulse signal is at a high level. Thus, the composition of the original single line data signal can be accurately decoded by the first determination unit 12.

In some embodiments, the clock signal can be first corresponded or synchronized with the original single line data signal, and then the first determination unit 12 can make the determination.

In some embodiments, the decoding module 10 may include an NSS signal generation unit. The NSS signal generation unit 13 can be configured to generate a second pulse signal with a fourth predetermined pulse width based on a first high-level rising edge of the second initial signal corresponding to the original single line data signal to generate an NSS signal.

In some embodiments, an endpoint of the second pulse signal may be an end of a data frame in the original single line data signal. In other words, a duration of the second pulse signal in the NSS signal is a length of one data frame.

In some embodiments, referring to FIGS. 3 and 6, the decoding module 10 may include a second determination unit 14. The second determination unit 14 can be configured to determine that a position of the original single line data signal is the end of a data frame when a low-level time of the original single line data signal exceeds a preset time.

It can be understood that there is a reset time at the end of a data frame in the single line protocol. When the second determination unit 14 detects that the low level time exceeds a Reset time, (TR) through a General Purpose Input/Output, (GPIO), Input/Output Port, (IO) port of the lamp splitter 1, it is considered that the data frame has ended. The first high-level rising edge detected afterwards is a starting point of a next data frame, until a high-level falling edge is generated when the next low-level time exceeds the TR. The synchronized data signal during the duration of the high level is a length of one data frame.

In some embodiments, referring to FIG. 7, the original single line data signal (Data), clock signal (Clock), and NSS signal (NSS) can be synchronously transmitted to form a complete set of SPI (Serial Peripheral Interface) signals to achieve the parsing of the single line protocol.

In other embodiments, the original single line data signal (Data) and clock signal (Clock) can also form an I2C (Inter Integrated Circuit) synchronous data transmission to achieve the parsing of single line protocols.

In some embodiments, the configuration information of the branch lamp number for each branch can be sent to the branch lamp confirmation module 20 through a user terminal.

In some embodiments, the user terminal may be a remote control, a mobile phone, a tablet, or other device.

In some embodiments, the lamp splitter 1 may further include a configuration module. The configuration module is configured to configure the configuration information of the branch lamp number for each branch, and send the configuration information of the branch lamp number for each branch to the branch lamp confirmation module.

In some embodiments, the configuration module may include a button or a touch screen, as well as related processing circuits, etc. Thus, the user can actively configure the branch lamp number for each branch through the button, touch screen, and other means.

Referring to FIG. 8, in some embodiments, the original single line data signal may carry the configuration information of the branch lamp number for each branch.

In some embodiments, the branch lamp number confirmation module 30 may include a plurality of cascaded branching devices 20 (such as a first branching device 21a, . . . a N^{th} branching device 21n, etc.). The original single line data signal can have or carry configuration information for each lamp. The configuration information may include the branch lamp number information. The branching devices can be configured to recognize the configuration information of the branch lamp number.

In some embodiments, the configuration information may further include information that controls a light emission state of the lamp (such as controlling five primary colors RGBCW of the light color).

In some embodiments, the branch lamp number can be determined by carrying the configuration information of branch lamps in the single line protocol sent by the controller 2.

In some embodiments, the lamp of the present disclosure may be an RGBCW bead. Each lamp can be controlled by two chips (such as WS2811 chip). The information for controlling RGBCW LED light beads can consist of 6 bytes. In the information for controlling RGBCW LED chips, first five bytes (40 bits) can be effective information for driving the LED chip's light emission state or color, used to control RGBCW separately, and a last byte (8 bits) can carry configuration information for the branch lamp number.

In some embodiments, the branching devices 20 can be configured to correspond to the configuration information of each light bead in the original single line data signal. Thus, through the corresponding branching devices 20, the branch lamp number configuration information in the configuration information can be accurately identified, rendering it convenient to independently allocate the configuration information to the corresponding branch.

In some embodiments, the branching devices 20 can be configured to correspond to the configuration information of a set of light beads in each branch in the original single line data signal. Each branching device 20 can be connected to one output terminal of the branch data output module. In this case, each branching device 20 can be connected to one output terminal of the branch data output module 30 and allocate an obtained branch lamp configuration information to the branch it controls, thereby controlling the LED light beads on the branch. This can reduce the configuration of the branching device 20, and achieve independent control of each branch.

In some embodiments, when the controller 2 sends data, the configuration information for the branch lamp number in the first branching device can be in a last byte of a data frame, the configuration information for the branch lamp number in a second branching device can be in a seventh to a last byte, the configuration information for the branch lamp number in a third branching device can be in a thirteenth to the last byte, and so on. Every six bytes, a branch lamp configuration information for the branching device can be configured.

In some embodiments, after decoding the original single line data signal at the lamp splitter 1, the last byte can be used as the current configuration information for the branch lamp number in the splitter device.

In some embodiments, the configuration channel for the branch lamp number information can be shifted 6 bytes backwards to ensure that the cascaded branching devices can also use the last byte as the current branch lamp number information. For example, if the current branching device 20 obtains the configuration information of the branch lamp number as Q, and a total data length of the decoded data frame is K bits, then a first 48 Q bits of data are to-be-outputted data for the branch 1, and a last K-48 Q bits of data are the to-be-outputted data for the branch 2.

In some embodiments, the branch data output module 30 allocates the decoded data to each branch through a SPI or a PWM analog single line protocol. In this case, the branch data output module 30 can output the decoded data to each branch so as to control the LED chips connected to the branches. By simulating the single line protocol, the branch data output module 30 can simulate a signal format and a timing emitted by the controller, ensuring that the LED light beads correctly understand and respond to the signals.

In the present disclosure, by outputting independent signals to each branch, the branch data output module 30 enables each branch (as well as the LED light beads on each branch) to be individually controlled, thereby enabling the light beads on each branch to achieve different color, brightness, and mode variations.

The present disclosure further provides a signal splitting method, which can be implemented by the lamp splitter 1.

In some embodiments, the signal splitting method may include step S100, decoding an input original single line data signal to output decoded data.

In some embodiments, the signal splitting method may include step S200, confirming a configuration information of a branch lamp number for each branch.

In some embodiments, the signal splitting method may include step S300, allocating the decoded data to each branch according to the configuration information of the branch lamp number for each branch.

In some embodiments, step S100 (i.e. decoding method) may include generating a first pulse signal (i.e. bit1, bit2, . . . bit8, etc. in FIG. 5) with a third predetermined pulse width when a high-level duration of a first initial signal corresponding to the original single line data signal (i.e. Data in FIG. 5) is greater than a high-level duration of 0 code, and generating a clock signal (i.e. Clock in FIG. 5) by combining all first pulse signals.

In some embodiments, step S100 may include sampling the original single line data signal at a position where the clock signal has the first pulse signal, and determining that a decoding bit is 0 code when it is sampled out that the decoding bit of the original single line data signal corresponding to the first pulse signal is at a low level; and determining that the decoding bit is 1 code when it is sampled out that the decoding bit of the original single line data signal corresponding to the first pulse signal is at a high level.

In some embodiments, step S100 may include generating a second pulse signal with a fourth predetermined pulse width based on a first high-level rising edge of the second initial signal corresponding to the original single line data signa to generate an NSS signal.

In some embodiments, an endpoint of the second pulse signal may be an end of a data frame in the original single line data signal. In other words, a duration of the second pulse signal in the NSS signal is a length of one data frame.

In some embodiments, step S100 may include determining that a position of the original single line data signal is the end of a data frame when a low-level time of the original single line data signal exceeds a preset time.

In some embodiments, step S200 may include recognizing a branch lamp configuration information through a cascaded branching device.

For other embodiments mentioned in the above method, please refer to the description of the lamp splitter 1, which will not be repeated here.

According to the lamp splitter 1, the lighting system, and the signal splitting method of the present disclosure, independent control of lamps can be achieved, which can improve the flexibility and reliability of the system.

Although the present disclosure has been specifically described in combination with the accompanying drawings and embodiments, it should be understood that the above description does not limit the present disclosure in any form. Technicians in this field can make modifications and changes to the present disclosure as needed without departing from the essential spirit and scope of the present disclosure, and these modifications and changes all fall within the scope of the present disclosure.

What is claimed is:

1. A lamp splitter, comprising:
a decoding module, configured to decode an input original single line data signal to output decoded data;
a branch lamp number confirmation module, configured to confirm a configuration information of a branch lamp number for each branch; and
a branch data output module, configured to allocate the decoded data to each branch according to the configuration information of the branch lamp number for each branch.

2. The lamp splitter according to claim 1, wherein the original single line data signal comprises a plurality of 0 codes and a plurality of 1 codes,
wherein the 0 codes have a high level with a first predetermined pulse width, and the 1 codes have a high level with a second predetermined pulse width,
wherein the second predetermined pulse width is greater than the first predetermined pulse width;
the decoding module comprises a clock signal generation unit configured to generate a first pulse signal with a third predetermined pulse width when a high-level duration of a first initial signal corresponding to the original single line data signal is greater than a high-level duration of the 0 codes so as to generate a clock signal.

3. The lamp splitter according to claim 2, wherein the third predetermined pulse width is not greater than a difference between the second predetermined pulse width and the first predetermined pulse width.

4. The lamp splitter according to claim 2, wherein the decoding module comprises a first determination unit,
wherein the first determination unit is configured to:
sample the original single line data signal at a position where the clock signal has the first pulse signal,
determine that a decoding bit is the 0 code when the decoding bit of the original single line data signal corresponding to the first pulse signal is at a low level; and
determine that the decoding bit is the 1 code when the decoding bit of the original single line data signal corresponding to the first pulse signal is at a high level.

5. The lamp splitter according to claim 1, wherein the decoding module comprises an NSS signal generation unit,
wherein the NSS signal generation unit is configured to generate a second pulse signal with a fourth predetermined pulse width based on a first high-level rising edge of the second initial signal corresponding to the original single line data signal to generate an NSS signal, and an endpoint of the second pulse signal is an end of a data frame in the original single line data signal.

6. The lamp splitter according to claim 5, wherein the decoding module comprises a second determination unit,
wherein the second determination unit is configured to determine that a position of the original single line data signal is the end of a data frame when a low-level time of the original single line data signal exceeds a preset time.

7. The lamp splitter according to claim 1, wherein the original single line data signal carries the configuration information of the branch lamp number for each branch.

8. The lamp splitter according to claim 1, wherein the configuration information of the branch lamp number for each branch is sent to the branch lamp number confirmation module through a user terminal.

9. The lamp splitter according to claim 1, further comprising:
a configuration module, configured to configure the configuration information of the branch lamp number for each branch, and send the configuration information of the branch lamp number for each branch to the branch lamp number confirmation module.

10. The lamp splitter according to claim 7, wherein the branch lamp number confirmation module comprises a plurality of cascaded branching devices,
the original single line data signal comprises configuration information for each lamp, and the configuration information comprises the configuration information of the branch lamp number;
the branching devices are configured to recognize the configuration information of the branch lamp number.

11. The lamp splitter according to claim 1, wherein the branch data output module allocates the decoded data to each branch through a SPI or a PWM analog single line protocol.

12. A signal splitting method, comprising:
decoding an input original single line data signal to output decoded data;
confirming a configuration information of a branch lamp number for each branch; and
allocating the decoded data to each branch according to the configuration information of the branch lamp number for each branch.

13. A lighting system, comprising:
a controller,
a plurality of lamps and a plurality of lamp control chips that are provided in a plurality of branches, and
the lamp splitter according to claim 1,
wherein the lamp splitter has a plurality of output terminals, and the plurality of output terminals are respectively connected to the plurality of branches;
each lamp is provided with at least one lamp control chip, and the controller is configured to output an original single line data signal to the lamp splitter;
the lamp splitter is configured to decode the original single line data signal and independently allocate to the lamp control chips that are connected to the lamps in the plurality of branches, and then control lighting states of the lamps by the lamp control chips;
wherein the controller is caused to execute:
decoding an input original single line data signal to output decoded data;
confirming a configuration information of a branch lamp number for each branch; and
allocating the decoded data to each branch according to the configuration information of the branch lamp number for each branch.

14. The lighting system according to claim 13, wherein the original single line data signal comprises a plurality of 0 codes and a plurality of 1 codes,
the 0 codes have a high level with a first predetermined pulse width, and the 1 codes have a high level with a second predetermined pulse width,
the second predetermined pulse width is greater than the first predetermined pulse width;
wherein the controller is further caused to execute:
generating a first pulse signal with a third predetermined pulse width when a high-level duration of a first initial signal corresponding to the original single line data signal is greater than a high-level duration of the 0 codes so as to generate a clock signal.

15. The lighting system according to claim 14, wherein the third predetermined pulse width is not greater than a difference between the second predetermined pulse width and the first predetermined pulse width.

16. The lighting system according to claim 13, wherein the controller is further caused to execute:
sampling the original single line data signal at a position where the clock signal has the first pulse signal,
determining that a decoding bit is the 0 code when the decoding bit of the original single line data signal corresponding to the first pulse signal is at a low level; and
determining that the decoding bit is the 1 code when the decoding bit of the original single line data signal corresponding to the first pulse signal is at a high level.

17. The lighting system according to claim 13, wherein the controller is further caused to execute:
generating a second pulse signal with a fourth predetermined pulse width based on a first high-level rising edge of the second initial signal corresponding to the original single line data signal to generate an NSS signal, and an endpoint of the second pulse signal is an end of a data frame in the original single line data signal.

18. The lighting system according to claim 13, wherein the controller is further caused to execute:
determining that a position of the original single line data signal is the end of a data frame when a low-level time of the original single line data signal exceeds a preset time.

19. The lighting system according to claim 13, wherein the controller is further caused to execute:
sending the configuration information of the branch lamp number for each branch through a user terminal.

20. The lighting system according to claim 13, wherein the controller is caused to execute:
allocating the decoded data to each branch through a SPI or a PWM analog single line protocol.
